(19) United States
(12) Patent Application Publication
(10) Pub. No.: US 2011/0271184 A1
(43) Pub. Date: Nov. 3, 2011

(54) CLIENT APPLICATION AND WEB PAGE INTEGRATION

(75) Inventors: YunRui SiMa, Beijing (CN); Hong Chen, Beijing (CN); Yingtao Dong, Redmond, WA (US); Jichao Zhang, Beijing (CN)

(73) Assignee: MICROSOFT CORPORATION, Redmond, WA (US)

(21) Appl. No.: 12/768,957

(22) Filed: Apr. 28, 2010

(51) Int. Cl. G06F 3/048

(52) U.S. Cl. 715/705; 715/764; 715/760

(57) ABSTRACT

Application integration may be provided. A first application may be executed on a client computer. The first application may connect to a second application, such as a browser-based application. The first application may identify at least one functionality associated with the second application and display a user interface element associated with the at least one functionality within the first application.

### BACKGROUND

Client application and web page integration is a process for providing interoperability between web browser-based functionality and standalone application functionality. In some situations, client-based application may execute on a computer without needing any network support, while browser-based applications may be executed within a web browser, alleviating the need to install an application on the client. This may, however, result in duplication of effort to develop two separate versions of a similar functionality. Furthermore, the two different applications may present inconsistent user experiences and may be unable to simultaneously make use of the local resources available to client applications and web browser functionality. This may result in confusion and inefficiencies among users that switch between the client and browser-based applications. The conventional strategy is to develop the two applications separately, but this often causes problems because the conventional strategy does not allow for integration, interoperability, and consistent user experience between the two versions.

### SUMMARY

Client application and web page integration may be provided. This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

Application integration may be provided. A first application may be executed on a client computer. The first application may connect to a second application, such as a browser-based application. The first application may identify at least one functionality associated with the second application and display a user interface element associated with the at least one functionality within the first application.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIGS. 2A-2B are block diagrams of sample applications;

FIG. 3 is a block diagram of an integrated client application;

FIG. 4 is a flow chart of a method for providing application integration; and

FIG. 5 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Client application and web page integration may be provided. Consistent with embodiments of the present invention, a design for providing interoperability between browser-based and client-based applications. The design may notify client-based applications of actions available on a related browser-based application so that the actions may be dynamically exposed on the client-based application's user interface (UI). Users may take actions through the client-based application's UI but the actions may take effect on data associated with the browser-based application. The client-based application may also execute additional business logic available in the client-based application, but not the browser-based application, before or after invoking actions exposed from the browser-based application.

For example, a company may develop two payroll applications. One application may comprise a client-based application and may be used by accounting to transfer salary to an employee's bank account. The other application may be developed as a browser-based application for generating payroll reports and allowing employees to check them through a web browser. Both applications may function correctly, but integration of the applications may allow the company to add additional business logic. Such logic may, for example, allow generation of the payroll report immediately after the salary is transferred. The payroll report may then be sent to the employee directly.

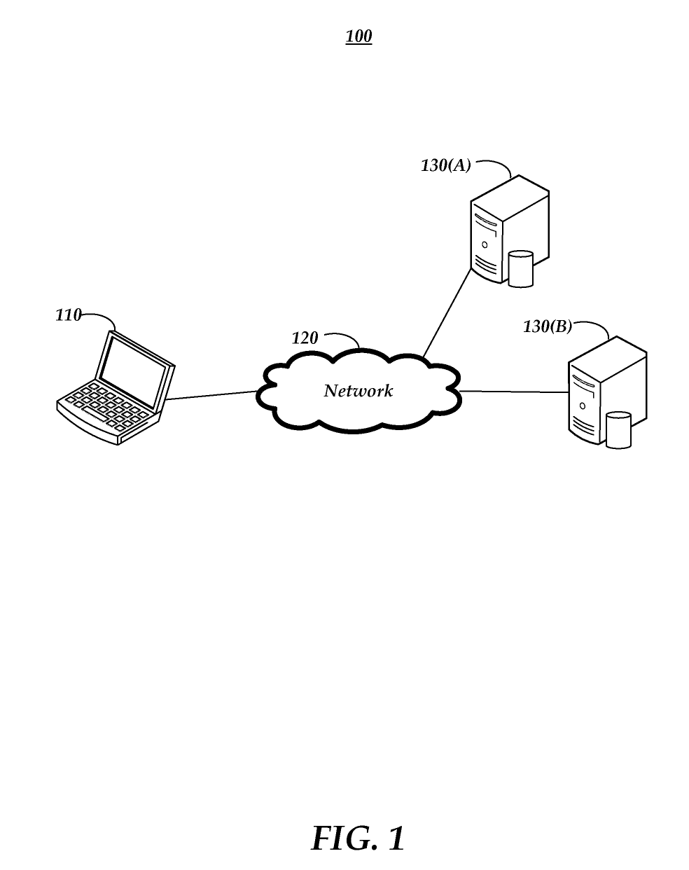

FIG. 1 is a block diagram of an operating environment 100. Operating environment 100 may comprise a client 110, a network 120, and a plurality of web servers 130(A)-(B). Network 120 may comprise, for example, a private network such as a corporate intranet and/or a public network such as the Internet. Web servers 130(A)-(B) may comprise computers operative to receive web page requests, such as from client 110, and respond with the requested web page. Web servers 130(A)-(B) may also be operative to provide an execution framework for browser-based applications. For example, client 110 may request, via a web browser application, a web page comprising a payroll reporting browser-based application. Web server 130(A), for example, may respond to the request with the web page and associated application. Client 110 may then request functionality associated with the browser-based application be performed by web server 130(A) via interactions with the web browser application.

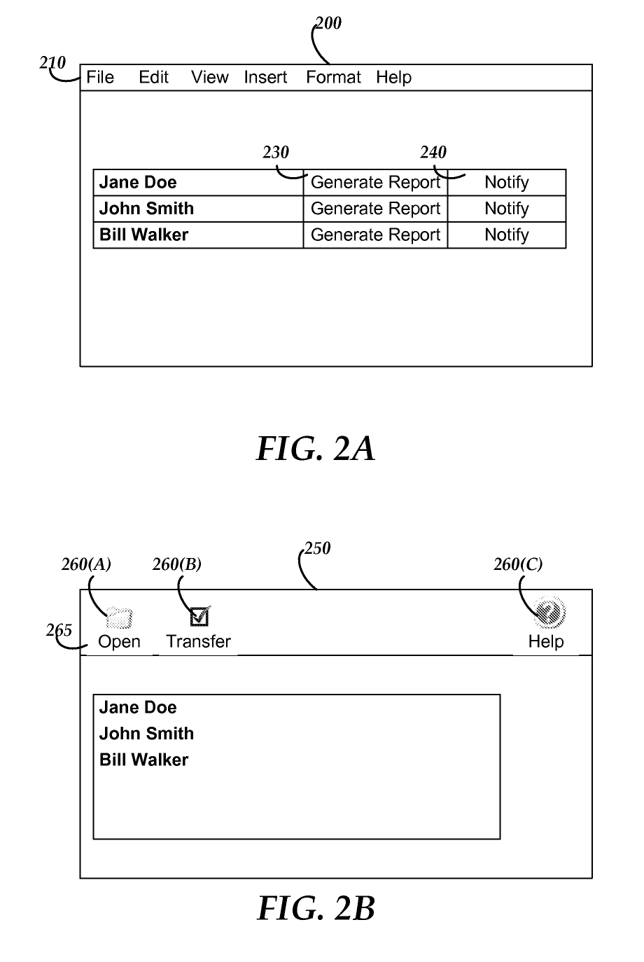

FIG. 2A is a block diagram of a sample browser-based application 200. Browser-based application 200 may comprise a user interface (UI) comprising a menu bar 210, a first function UI element 230 and a second function UI element 240. For example, browser-based application 200 may comprise a financial application comprising employee data and functions for generating a report, associated with first function UI element 230, and/or notifying an employee that a transaction has been completed, associated with second function UI element 240.

FIG. 2B is a block diagram of a client application 250. Client application 250 may comprise a user interface ribbon 265 comprising a plurality of UI action elements 260(A)-(C). Client application 250 may comprise, for example, an accounting application comprising employee data and functions for executing a funds transfer to accounts associated with the employees.

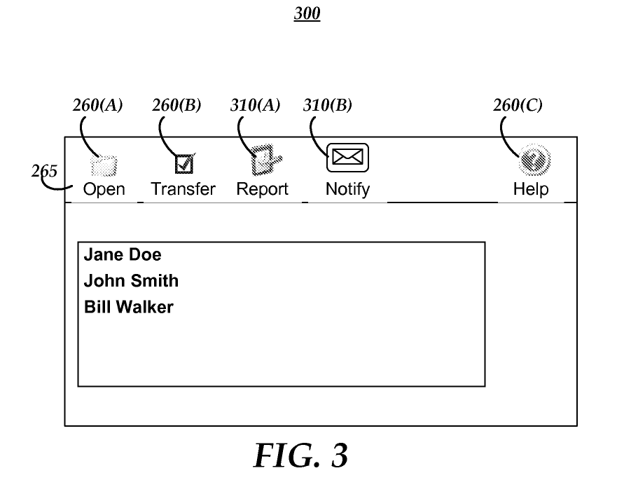

FIG. 3 is a block diagram of an integrated client application 300. Integrated client application may comprise user interface ribbon 265 comprising plurality of UI action elements 260(A)-(C) and plurality of integrated UI elements 310(A)-(B). Integrated UI elements 310(A)-(B) may be incorporated into user interface ribbon 265 based on functions exposed by browser-based application 200. Consistent with embodiments of the invention, integrated client application 300 may be operative to access, modify, and/or synchronize employee data associated with browser-based application 200.

Instead of rendering a web page separately from an existing UI, integrated client application 300 may integrate actions exposed by browser-based application 200 to achieve a consistent user experience. For example, functions associated with first function UI element 230 and/or second function UI element 240 may be displayed in user interface ribbon 265 according to a visual appearance associated with integrated client application 300. The visual appearance may comprise configuration details such as colors, text styles, locations, icons, and/or menu placements.

Consistent with embodiments of the invention, integrated client application 300 may be initialized upon a user request to open the application. Integrated client application 300 may load a web page according to a uniform resource locator (URL) associated with a configuration of integrated client application 300. A WebBrowser control may comprise a standard ActiveX™ control or a managed control published, for example, with the .Net framework and may allow integrated client application 300 to access browser-based application 200 similar to a conventional web browser application.

After the web page is loaded, the web page may expose its content to integrated client application 300. For the example financial application described above, the “Generate Report” and “Notify” functions and/or the employee data associated with browser-based application 200 may be exposed to the client-based application. Other examples of exposed data may comprise help text, topic indices, and/or method invocation addresses or names.

Data and functions associated with browser-based application 200 may be exposed, for example, by causing browser-based application 200 to invoke a method implemented in integrated client application 300. Browser-based application 200 may then exchange data and/or function references to integrated client application 300. Browser-based application 200 may be responsible for building all necessary information into a string and passing it to integrated client application 300.

The exchange may compose several segments. For example, each segment may comprise a title (e.g., “HelpId”) and/or a value string (e.g., “<HelpID>”). The value string may identify a category associated with the segment, which may be used in configuring a visual appearance for a user interface element associated with the segment within integrated client application 300. In the HelpID segment, the value may comprise a string of data. In another example, such as a Method List segment, the value may comprise be a plurality of method name and method address pairs that may map a method to its name and allow its invocation later. Browser-based application 200 may pass the segment(s) to integrated client application 300 by invoking a method such as the javascript method “window.external.Expose (segmentString);” included in a web page associated with browser-based application 200.

Consistent with embodiments of the invention, data and functions may also be exposed by extending HTML to add additional tags for exposing those data and functions. A web page may specify which data and/or functions may be exposed in the HTML and integrated client application 300 may parse these tags. Integrated client application 300 may then expose the associated actions to its toolbar, context menu, and/or other controls specified by tag, such as UI ribbon 265. The syntax of tags may comprise for example:

<Toolbar>

<button name=“Generate a report” onclick=“GenerateReport( )”/>

</Toolbar>

Within the toolbar tag, data and functions, such as GenerateReport, may be exposed to integrated client application 300. The tag may also specify which control may represent it. In this example above, a button may be added to ribbon UI 265 of integrated client application 300 after parsing the HTML. A user of integrated client application 300 may click the “Generate a report” button (e.g., integrated UI element 310(A)) in UI ribbon 265 to cause browser-based application 200 to generate a report. Additionally, pre- and/or post-invocation functionality may be executed by integrated client application 300 before and/or after invoking the browser-based function.

Actions or methods that are invoked by integrated client application 300 may be executed by browser-based application 200. Browser-based application 200 may then also send a finished notification to integrated client application 300 comprising a success/failure result and/or additional data.

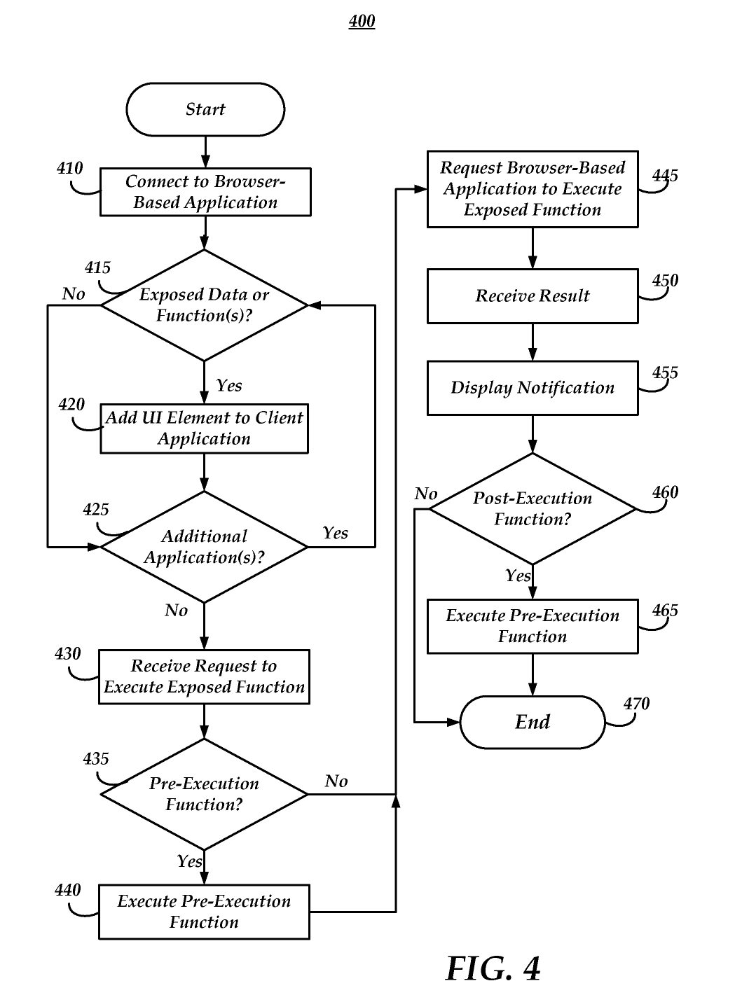

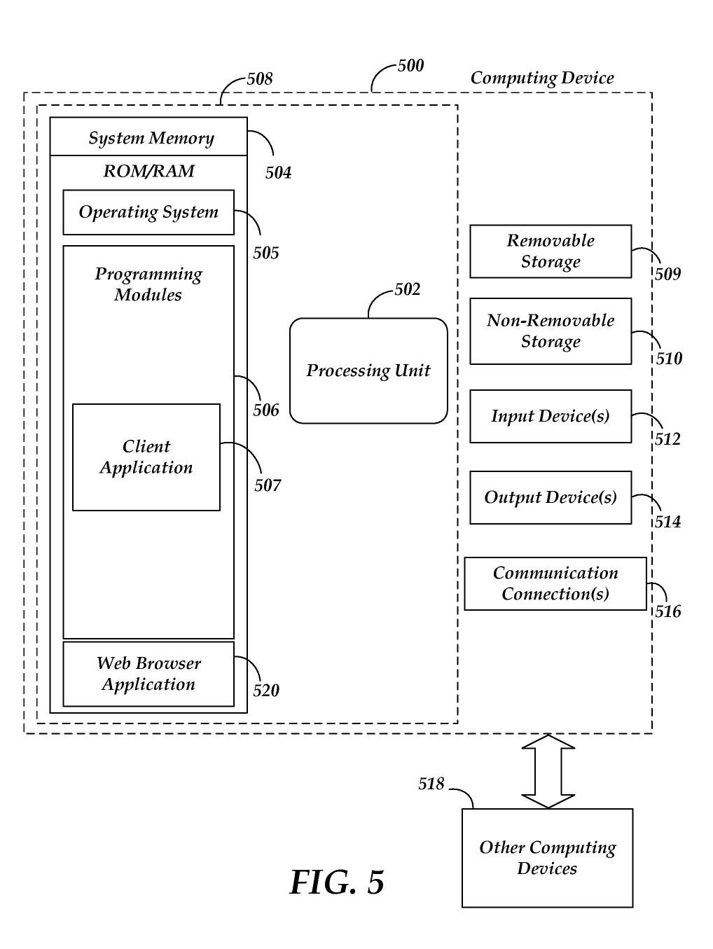

FIG. 4 is a flow chart setting forth the general stages involved in a method 400 consistent with an embodiment of the invention for providing application integration. Method 400 may be implemented using a computing device 500 as described in more detail below with respect to FIG. 5. Ways to implement the stages of method 400 will be described in greater detail below. Method 400 may begin at starting block 405 and proceed to stage 410 where computing device 500 may initialize a client application and connect to a browser-based application. For example, client 110 may receive a request from a user to initialize client application 250. Client application 250 may then connect to browser-based application 200 according to a web location, such as a URL, associated with a configuration of client application 250.

From stage 410, method 400 may advance to stage 415 where computing device 500 may determine whether the browser-based application comprises any exposed data and/or functions. For example, browser-based application 200 may execute a javascript method to expose data and/or functions to client application 250. Consistent with embodiments of the invention, client application 250 may parse a web page of browser-based application 200 to identify any exposed data and/or functions.

If exposed elements are identified at stage 415, method 400 may advance to stage 420 where computing device 500 may add a user interface element to the client application. For example, client application 250 may add plurality of integrated UI elements 310(A)-(B) associated with exposed functions of browser-based application 200, resulting in the user interface of integrated client application 300. Integrated client application 300 may apply a visual style associated with client application 250 to integrated UI elements 310(A)-(B) in order to provide a consistent user experience to a user of integrated client application 300.

From stage 420, or if no exposed data and/or functions are identified in stage 415, method 400 may advance to stage 425 where computing device 500 may determine whether any additional web pages and/or browser-based applications are associated with client application 200. If so, method 400 may return to stage 415 and determine whether each of the other pages/applications expose data and/or functions to be integrated into integrated client application 300.

Once no more browser-based pages/applications need to be accessed for exposed data/functions, method 400 may advance to stage 430 where computing device 500 may receive a request to execute an exposed function. For example, a user may select integrated UI element 310(A) to generate a report.

Method 400 may then advance to stage 435 where computing device 500 may determine whether any pre-execution functions are defined. For example, integrated client application 300 may define a function, such as verifying that all pending transfers have completed in a financial application, prior to executing the exposed function associated with integrated UI element 310(A).

If a pre-execution function is defined, method 400 may advance to stage 440 where computing device 500 may execute the pre-execution function. For example, integrated client application 300 may invoke the verification function described above. Consistent with embodiments of the invention, if the pre-execution function fails, method 400 may end at stage 470 and display a message to the user, such as an error and/or a failure notice.

After executing the pre-execution function at stage 440, or if no pre-execution function is determined to be defined at stage 435, method 400 may advance to stage 445 where computing device 500 may request that the browser-based application execute the exposed function. For example, integrated client application 300 may send a request to invoke the exposed function to browser-based application 200. Consistent with embodiments of the invention, integrated client application 300 may be operative to receive a change to data exposed by browser-based application in addition to and/or instead of receiving a request to execute an exposed function. Integrated client application 300 may therefore, at stage 445, notify browser-based application 200 of the change to the data and browser-based application 200 may save the changed data to a data store associated with browser-based application 200.

From stage 445, method 400 may advance to stage 450 where computing device 500 may receive a result associated with the invocation of the exposed function. For example, browser-based application 200 may send a success/failure message and/or additional data associated with executing the function to integrated client application 300.

From stage 450, method 400 may advance to stage 455 where computing device 500 may display a notification to the user associated with the invocation of the exposed function. For example, integrated client application 300 may display an icon, text display, dialog box, and/or other user interface element indicating that the execution of the exposed function has been completed and may indicate the success or failure of the action as provided in the notification.

Method 400 may then advance to stage 460 where computing device 500 may determine whether any post-execution functions are defined. For example, integrated client application 300 may define a function, such as creating a log entry, after executing the exposed function associated with integrated UI element 310(A).

If a post-execution function is defined, method 400 may advance to stage 465 where computing device 500 may execute the post-execution function. For example, integrated client application 300 may invoke the logging function described above. After executing the post-execution function at stage 465, or if no post-execution function is determined to be defined at stage 460, method 400 may end at stage 470.

An embodiment consistent with the invention may comprise a system for providing application integration. The system may comprise a memory storage and a processing unit coupled to the memory storage. The processing unit may be operative to execute a first application, connect to a second application from the first application, identify at least one functionality associated with the second application, and display a user interface element associated with the at least one functionality within the first application. The processing unit may be further operative to identify an action category associated with the at least one functionality and assign a visual appearance to the user interface element associated with the action category. For example, if the exposed data comprises a help topic, the processing unit may assign the help topic to a location within a help menu and/or assign a question mark icon to a UI element operable to access the help topic.

Another embodiment consistent with the invention may comprise a system for providing application integration. The system may comprise a memory storage and a processing unit coupled to the memory storage. The processing unit may be operative to initialize a first application and determine whether at least one second application comprises an exposed element. If so, the processing unit may be operative to display an indication within a user interface of the first application that the exposed element of the at least one second application is available to a user of the first application.

Yet another embodiment consistent with the invention may comprise a system for providing application integration. The system may comprise a memory storage and a processing unit coupled to the memory storage. The processing unit may be operative to connect to at least one browser-based application from a client-based application, identify at least one exposed function associated with the at least one browser-based application, display a user interface element within the client-based application associated with the at least one exposed function, receive a request to execute the at least one exposed function, and determine whether the client-based application comprises a pre-execution function associated with the at least one exposed function. If the client based-application comprises the pre-execution function, the processing unit may be operative to execute the pre-execution function. The processing unit may then send a request to execute the at least one exposed function to the at least one browser-based application, receive a result from the at least one browser-based application associated with the request to execute the at least one exposed function by the at least one browser-based application, display a notification associated with the received result to the user of the client-based application, and determine whether the client-based application comprises a post-execution function associated with the at least one exposed function. If so, the processing unit may be operative to execute the post-execution function.

FIG. 5 is a block diagram of a system including computing device 500. Consistent with an embodiment of the invention, the aforementioned memory storage and processing unit may be implemented in a computing device, such as computing device 500 of FIG. 5. Any suitable combination of hardware, software, or firmware may be used to implement the memory storage and processing unit. For example, the memory storage and processing unit may be implemented with computing device 500 or any of other computing devices 518, in combination with computing device 500. The aforementioned system, device, and processors are examples and other systems, devices, and processors may comprise the aforementioned memory storage and processing unit, consistent with embodiments of the invention.

With reference to FIG. 5, a system consistent with an embodiment of the invention may include a computing device, such as computing device 500. In a basic configuration, computing device 500 may include at least one processing unit 502 and a system memory 504. Depending on the configuration and type of computing device, system memory 504 may comprise, but is not limited to, volatile (e.g. random access memory (RAM)), non-volatile (e.g. read-only memory (ROM)), flash memory, or any combination. System memory 504 may include operating system 505, one or more programming modules 506, and may include a client application 507. Operating system 505, for example, may be suitable for controlling computing device 500's operation. In one embodiment, programming modules 506 may include a web browser application 520. Furthermore, embodiments of the invention may be practiced in conjunction with a graphics library, other operating systems, or any other application program and is not limited to any particular application or system. This basic configuration is illustrated in FIG. 5 by those components within a dashed line 508.

Computing device 500 may have additional features or functionality. For example, computing device 500 may also include additional data storage devices (removable and/or non-removable) such as, for example, magnetic disks, optical disks, or tape. Such additional storage is illustrated in FIG. 5 by a removable storage 509 and a non-removable storage 510. Computer storage media may include volatile and nonvolatile, removable and non-removable media implemented in any method or technology for storage of information, such as computer readable instructions, data structures, program modules, or other data. System memory 504, removable storage 509, and non-removable storage 510 are all computer storage media examples (i.e memory storage.) Computer storage media may comprise, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 500. Any such computer storage media may be part of device 500 and may comprise non-transitory storage media. Computing device 500 may also have input device(s) 512 such as a keyboard, a mouse, a pen, a sound input device, a touch input device, etc. Output device(s) 514 such as a display, speakers, a printer, etc. may also be included. The aforementioned devices are examples and others may be used.

Computing device 500 may also contain a communication connection 516 that may allow device 500 to communicate with other computing devices 518, such as over a network in a distributed computing environment, for example, an intranet or the Internet. Communication connection 516 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 504, including operating system 505. While executing on processing unit 502, programming modules 506 (e.g. web browser application 520) may perform processes including, for example, one or more of method 400's stages as described above. The aforementioned process is an example, and processing unit 502 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing application integration, the method comprising:
executing a first application;
connecting to a second application from the first application;
identifying at least one functionality associated with the second application; and
displaying a user interface element associated with the at least one functionality within the first application.

2. The method of claim 1, wherein the first application comprises a client-based application.

3. The method of claim 1, wherein the second application comprises a web browser-based application.

4. The method of claim 1, further comprising:
retrieving a selection of the displayed user interface element by a user of the first application; and
invoking the at least one functionality associated with the second application.

5. The method of claim 4, further comprising:
determining whether at least one second functionality is provided by the first application and associated with invoking the at least one functionality; and
in response to determining that the at least one second functionality is provided by the first application and associated with invoking the at least one functionality, invoking the at least one second functionality by the first application.

6. The method of claim 4, further comprising receiving a result notification by the first application from the second application.

7. The method of claim 6, further comprising displaying the result notification to the user of the first application.

8. The method of claim 1, wherein displaying the user interface element associated with the at least one functionality within the first application comprises:
identifying an action category associated with the at least one functionality; and
assigning a visual appearance to the user interface element associated with the action category.

9. The method of claim 6, wherein the visual appearance assigned to the user interface element comprises at least one of the following: a color, a text style, a location, an icon, and a menu placement.

10. A computer-readable medium which stores a set of instructions which when executed performs a method for providing application integration, the method executed by the set of instructions comprising:
initializing a first application;
determining whether at least one second application comprises an exposed element; and
in response to determining that the at least one second application comprises an exposed element, displaying an indication within a user interface of the first application that the exposed element of the at least one second application is available to a user of the first application.

11. The computer-readable medium of claim 10, wherein the exposed element comprises a data element.

12. The computer-readable medium of claim 11, further comprising:
receiving an action request from the user of the first application;
determining whether the action request comprises a change to the data element; and
in response to determining that the action request comprises a change to the data element, informing the at least one second application of the change to the data element.

13. The computer-readable medium of claim 11, wherein the data element comprises a help topic.

14. The computer-readable medium of claim 13, wherein displaying the indication within the user interface of the first application that the exposed element of the at least one second application is available to a user of the first application comprises adding the help topic to a help menu associated with the first application.

15. The computer-readable medium of claim 10, wherein the exposed element comprises a function.

16. The computer-readable medium of claim 15, wherein displaying the indication within the user interface of the first application that the exposed element of the at least one second application is available to a user of the first application comprises adding at least one action element to a user interface associated with the first application.

17. The computer-readable medium of claim 16, further comprising:
receiving a selection of the at least one action element as an input from the user of the first application; and
invoking the function on the at least one second application.

18. The computer-readable medium of claim 17, further comprising:
receiving a result notification from the at least one second application in response to invoking the function; and
displaying, to the user of the first application, a message associated with the result notification received from the at least one second application.

19. The computer-readable medium of claim 10, further comprising:
identifying a plurality of exposed elements, wherein each of the plurality of exposed elements is associated with at least one of a plurality of browser-based applications; and
creating an element within the user interface of the first application associated with each of the plurality of exposed elements.

20. A system for providing application integration, the system comprising:
a memory storage; and
a processing unit coupled to the memory storage, wherein the processing unit is operative to:
connect to at least one browser-based application from a client-based application,
identify at least one exposed function associated with the at least one browser-based application,
display a user interface element within the client-based application, wherein the user interface element is associated with the at least one exposed function,
receive a request to execute the at least one exposed function via the user interface element from a user of the client-based application,
determine whether the client-based application comprises a pre-execution function associated with the at least one exposed function,
in response to determining that the client-based application comprises a pre-execution function associated with the at least one exposed function, execute the pre-execution function,
send a request to execute the at least one exposed function to the at least one browser-based application,
receive a result from the at least one browser-based application associated with the request to execute the at least one exposed function by the at least one browser-based application,
display a notification associated with the received result to the user of the client-based application,
determine whether the client-based application comprises a post-execution function associated with the at least one exposed function, and
in response to determining that the client-based application comprises a post-execution function associated with the at least one exposed function, execute the post-execution function.
